(19) United States
(12) Patent Application Publication
(10) Pub. No.: US 2010/0258641 A1
(43) Pub. Date: Oct. 14, 2010

(54) 3-in-1 barcode for identifying commodity

(76) Inventor: Zhi Yu, Guangdong (CN)

Correspondence Address: BACON & THOMAS, PLLC, 625 SLATERS LANE, FOURTH FLOOR, ALEXANDRIA, VA, 22314-1176, US

(21) Appl. No.: 12/085,951

(22) PCT Filed: Dec. 29, 2007
(86) PCT No.: PCT/CN2007/003955

§ 371 Date: Jun. 3, 2008

(30) Foreign Application Priority Data
Jan. 15, 2007 (CN) 200710072853.6
Sep. 12, 2007 (CN) 2007-10199599.6

(51) Int. Cl. G06K 19/06

(52) U.S. Cl. 235/494

(57) ABSTRACT

A 3-in-1 barcode for identifying a commodity, involving a commercial cipher technology, is implemented through the following steps: acquiring a first and second group of data in the form of 13-digit decimal number that are input into a computer for being processed; determining whether the first group of data satisfies an EAN-13 encoding principle or not, and whether the second group of data satisfies an commodity flow number encoding principle or not, if yes, proceeding to the next step, otherwise, generating an error prompt; performing an encryption operation on the first group of data satisfying the EAN-13 encoding principle and the second group of data satisfying the commodity flow number encoding principle through a commercial cipher algorithm, and generating a 13-digit decimal verification code data; dividing the first group of data, the second group of data, and the verification code data into three rows by the computer; and storing and printing the 3-in-1 barcode divided into three rows by the computer, for machine identification. The advantage of the present invention lies in that the 3-in-1 barcode has a plain part and a cipher part, which is easily identified by both the users and consumers, and cannot be easily counterfeited and forged.

### BACKGROUND OF THE INVENTION

1. Field of the Invention

The present invention relates to an application of a commercial cipher technology in identifying commodities, which is a digital authentification code capable of identifying the commodity, and more particularly to a method of generating such code.

2. Related Art

As a science, cryptography has a long history. With the development of computer and information technology, cryptography has also been rapidly developed, and the applications thereof have been continuously expanded, and currently, socialization and individuation trends have appeared all over the world. For example, the cryptography is applied to the value-added tax invoice, which can prevent counterfeit and falsification, so as to put an end to national tax dodging, smuggling, evading, and tax fraud, and by using the value-added tax invoice, it is quite convenient for tax audit.

Regulation on the Administration Commercial Cipher Codes are issued by the State Council of China on Oct. 7, 1999.

In January, 2006, the State Encryption Administration of China approves the Security Hash Algorithm: SHA-256; and Random Number Generation Algorithm: independent selection.

The barcode technology has advantages of high input speed, high reliability, large information, and high flexibility, which thus has been widely applied.

EAN-13 barcode is a global universal barcode used to identify commodities in the circulation sector, and the corresponding relationship between the EAN-13 barcode and the commodities is a one-to-many association. The manufacturer cannot clearly supervise the commodities under circulation, such that the circulation is disordered. The EAN 13 barcode is easily counterfeited and forged, which brings a lot of inconveniences to the consumers.

### SUMMARY OF THE INVENTION

The technical problem to be solved by the present invention is to identify and supervise each commodity. The present invention provides a “3-in-1 barcode” for identifying a commodity, which has a one-to-one relation with each commodity. It is not easily counterfeited and forged, so that the manufacturer can supervise the overall circulation process of each commodity from leaving factory to reaching the final consumers, such that the circulation sequence is clear and in order. The present invention further provides a method of generating, querying, and comparing the “3-in-1 barcode”.

The objective of the present invention can be realized through the following technical solution, in which a 3-in-1 barcode for identifying a commodity is implemented through the following steps:

(1) acquiring a first group of data and a second group of data in the form of 13-digit decimal number that are input into a computer for being processed;

(2) determining whether the first group of data satisfies a global universal EAN-13 encoding principle or not, and whether the second group of data satisfies a commodity flow number encoding principle or not, and if yes, proceeding to a next step; otherwise, generating an error prompt;

(3) performing an encryption operation on the first group of data satisfying the EAN-13 encoding principle and the second group of data satisfying the commodity flow number encoding principle through a commercial cipher algorithm, and generating a 13-digit decimal verification code data, i.e., a third group of data;

(4) dividing the first group of data, the second group of data, and the third group of data into three rows by the computer, so as to obtain a 3-in-1 barcode;

(5) storing and printing the 3-in-1 barcode divided into three rows by the computer, for machine identification.

In the 3-in-1 barcode for identifying a commodity, an encoding principle for the second group of data in the form of 13-digit decimal number, i.e., the commodity flow number encoding principle includes that, the 1^{st}-4^{th} digits indicate a 4-digit year code, the 5^{th}-6^{th} digits indicate a 2-digit month code, the 7^{th}-8^{th} digits indicate a 2-digit date code, and the 9^{th}-13^{th} digits indicate a 5-digit commodity flow number code.

In the 3-in-1 barcode for identifying a commodity, after the verification code is obtained, the verification code is decrypted through a commercial cipher algorithm to obtain the first and second group of data in the form of 13-digit decimal number.

In the 3-in-1 barcode for identifying a commodity, the first, second, and third groups of data are respectively printed in lower, middle, and upper rows by using EAN-13 barcodes.

The efficacy of the present invention lies in that, the 3-in-1 barcode has a plain part and a cipher part, such that it is easily identified by both the users and consumers, and it cannot be easily counterfeited and forged.

### BRIEF DESCRIPTION OF THE DRAWINGS

The present invention will become more fully understood from the detailed description given herein below for illustration only, which thus is not limitative of the present invention, and wherein:

FIG. 1 is a contrast view of a 3-in-1 barcode and an EAN-13 barcode;

FIG. 2 shows a flow for generating the 3-in-1 barcode;

FIG. 3 shows an identification of the 3-in-1 barcode;

FIG. 4 shows a comparison of the 3-in-1 barcode; and

FIG. 5 is a data flow chart for the 3-in-1 barcode.

### DETAILED DESCRIPTION OF THE INVENTION

In the present invention, on the basis of the EAN-13 barcode, a commodity flow number code and a verification code are further added. An EAN-13 barcode uniquely identifies one kind of commodities all over the world, a commodity flow number code uniquely identifies one commodity in one kind of commodities, and a verification code is generated by encrypting the EAN-13 barcode and the flow number code through the commercial cipher algorithm. After the verification code is obtained, the EAN-13 barcode and the flow number code can be obtained by decryption through the commercial cipher algorithm, so as to achieve the verification objective. The 3-in-1 barcode uniquely identifies one commodity all over the world, and the probability of guessing one commodity is 10⁻¹³, so the error for identifying the commodity by the 3-in-1 barcode is 10⁻¹³.

I. EAN-13 Barcode of the Commodity:

Recently, China is a member of European Article Number (EAN), and managed by the Article Numbering Center, so that the manufacturers can submit an application for using the barcodes. The EAN barcode is divided into EAN-13 codes and EAN-8 codes, in which the EAN-13 codes are generally used on common commodities and the EAN-8 codes are used on the commodities with extremely small volume.

(i) EAN-13 barcode encoding principle

The 1^{st}-3^{rd} digits indicate a country code;

the 4^{th}-7^{th} digits indicate a manufacturer code;

the 8^{th}-12^{th} digits indicate a product code; and

the 13^{th} digit indicates a check code.

The first three digits are universally allocated all over the world, and China is marked as 690-695.

If the barcode begins with 690 or 691, the 4^{th}-7^{th} digits indicate the manufacturer code, and the 8^{th}-12^{th} digits indicate the product code.

If it begins with 692 or 695, the 4^{th}-8^{th} digits indicate the manufacturer code, and the 9^{th}-12^{th} digits indicate the product code.

The last digit is a check code.

(ii) Code of book category

1. EAN-13 barcode

The 1^{st}-3^{rd} digits indicate a code of a book category 978;

the 4^{th}-12^{th} digits indicate the first 9 digits of the former ISBN code; and

the 13^{th} digit is a check code.

2. ISBN code

The 1^{st}-3^{rd} digits indicate a region code;

the 4^{th}-5^{th} digits indicate a code of a publishing house;

the 6^{th}-9^{th} digits indicate a code of a publication; and

the 10^{th} digit is a check code.

3. Corresponding relation between ISBN and EAN-13

978+the first 9 digits of ISBN+EA check code

(iii) Code of periodical category

1. EAN-13 barcode

The 1^{st}-3^{rd} digits indicate a code of a periodical 977;

the 4^{th}-10^{th} digits are the first 7 codes of the former ISSN code;

the 11^{th}-12^{th} digits are 00; and

the 13^{th} digit is a check code.

2. ISBN code

The 1^{st}-7^{th} digits indicate an international standard serial number; and

the 8^{th} digit indicates a check code.

3. Corresponding relation between ISSN and EAN

977+the first 7 digits of ISSN+00+EA check code

(International Standard Serial Number)

(iv) Relation between EAN-8 and EAN-13:

1. EAN-8 code encoding principle

The 1^{st}-3^{rd} digits indicate a country code;

the 4^{th}-7^{th} digits indicate a manufacturer code; and

the 8^{th} digit is a check code.

2. Conversion from EAN-8 into EAN-13

Reserving: the 1^{st}-3^{rd} digits indicate the country code; and
the 4^{th}-7^{th} digits indicate the manufacturer code.

Adding: the 8^{th}-12^{th} digits are 00000; and
the 13^{th} digit is the EAN-13 check code.

3. Relation between EAN-8 and EAN-13:

the first 7 digits of EAN-8+00000+EAN-13 check code

(v) Relation between EAN-13 barcode and UPC code

When entering to the USA and Canada, the products need to apply for UPC code, which is compatible with the EAN-13 barcode.

II. Flow Number Code of Commodity

1. If the daily yield of the products is not more than 100 thousand,

the 1^{st}-4^{th} digits indicate a 4-digit year code (e.g., the year of 2007),

the 5^{th}-6^{th} digits indicate a 2-digit month code (e.g., November),

the 7^{th}-8^{th} digits indicate a 2-digit date code (e.g., the day of 21^{th}), and

the 9^{th}-13^{th} digits indicate a 5-digit commodity flow number code (e.g., 00000-99999).

2. If the daily yield of the products is not more than 1 million,

the 1^{St}-3^{rd} digits indicate a 3-digit year code (e.g., the year of 2007 is marked as 007),

the 4^{th}-5^{th} digits indicate a 2-digit month code (e.g., November),

the 6^{th}-7^{th} digits indicate a 2-digit date code (e.g., the day of 21^{th}), and

the 8^{th}-13^{th} digits indicate a 6-digit commodity flow number code (e.g., 000000-999999).

3. If the daily yield of the products is not more than 10 million,

the 1^{St}-2^{nd} digits indicate a 2-digit year code (e.g., the year of 2007 is marked as 07),

the 3^{rd}-4^{th} digits indicate a 2-digit month code (e.g., November),

the 5^{th}-6^{th} digits indicate a 2-digit date code (e.g., the day of 21^{th}), and

the 7^{th}-13^{th} digits indicate a 7-digit commodity flow number code (e.g., 0000000-9999999).

III. Verification Code

The verification code is a 13-digit decimal number generated by encrypting the first group of EAN-13 barcode and the second group of flow number code through the commercial cipher algorithm, which is unique and random.

The 3-in-1 barcode is obtained by respectively arranging the above three groups of data in the lower, middle, and upper rows. The 3-in-1 barcode uniquely identifies one commodity worldwide, which can be used to identify and discriminate the commodities by means of encryption and decryption through the commercial cipher algorithm for authentification.

The 3-in-1 barcode is printed on the commodity in the form of three rows by taking the EAN-13 barcode as data carrier, for identifying a commodity.

IV. The 3-in-1 Barcode Manufactured According to the Above Steps has the Following Advantages.

The 3-in-1 barcode is formed by two groups of plain texts and one group of cipher text. The security and reliability of the 3-in-1 barcode is based on the confidentiality of cipher algorithm and cipher key, so the disclosure of the cipher text does not affect the security of the cipher algorithm. The possibility for breaking the cipher algorithm is considered as not existed herein.

The 3-in-1 barcode is formed by 39 digits decimal numbers, and the variance thereof is 10³⁹, which ensures that each commodity has a unique 3-in-1 barcode. The 3-in-1 barcode is formed by three groups of 13-digit decimal numbers, in which 26 digits are the plain text, and 13 digits are the verification code, i.e., the cipher text. Therefore, the probability for guessing the 3-in-1 barcode is 10⁻¹³, and it is apparently a small probability event, even though it is successfully guessed, it does not cause any threads to the other 3-in-1 barcodes.

A three-party authentification mechanism is established, in which the authentification center owns the cipher algorithm and the cipher key, the manufacturer owns the 3-in-1 barcode, and the consumer owns the commodity. The consumer logs in the manufacturer's website to query whether the commodity is genuine or not according to the 3-in-1 barcode on the commodity. If the 3-in-1 barcode is consistent with that held by the manufacturer, the manufacturer gives a prompt about a certain state of the commodity with this 3-in-1 barcode at a certain time and a certain place. Then, the consumer determines whether the 3-in-1 barcode is true or not according to the prompt, and if it is inconsistent with the prompt, the commodity is immediately called back and the 3-in-1 barcode is abolished. If the plain text is inconsistent, the manufacturer determines: the product is fake. If the verification code is inconsistent, the authentification center determines whether it is true or not: the one with the consistent verification code is true; otherwise, it is false.

The 3-in-1 barcode query system provides various query manners, including fixed-line phone, network, POS system, and mobile phone, which is simply operated and conveniently and quickly used. The consumer can perform the authentication independently, and can perform the authentication for many times.

The 3-in-1 barcode has a small volume (3 cm*3 cm), and large information (10³⁹), and can be visualized.

V. Application of the 3-in-1 Barcode

1. The 3-in-1 barcode is used to prevent fake products, without causing an additional research and development cost for the manufacturers and consumers, or requiring a specific device to assist in reading and writing operations. The 3-in-1 barcode is environmental-protective and cost-effective, which is an exploration of anti-counterfeiting technique from confidentiality to public disclosure, and is also an application of the cryptography in the anti-counterfeiting field. Currently, the existing anti-counterfeiting measures mainly include anti-counterfeiting ink, anti-counterfeiting stamp ink, barcode anti-counterfeiting, watermark anti-counterfeiting, structural anti-counterfeiting, holographic anti-counterfeiting, and nuclear double card anti-counterfeiting techniques, which achieve the anti-counterfeiting function to a certain extent. But the recognition and authentication of some anti-counterfeiting marks must be assisted by specific devices, so that the consumers cannot perform the authentication independently. In addition, the illegal use of the anti-counterfeiting marks may result in huge loss for the society, so the anti-counterfeiting measures cannot achieve better unification between efficiency and operability.

2. The 3-in-1 barcode is applied to enterprise management, to provide a digital platform satisfying the international standard for the digital management of each commodity. The 3-in-1 barcode has a one-to-one association with the products, so that the manufacturer establishes a product tracing system and creates a tracing file for each product. Therefore, the manufacturer can supervise an overall circulation process of each product from being produced to reaching the final consumer, so as to provide the most accurate information and obtain the most precious time for the callback of products, thereby ensuring the legal rights of the consumers in a better way.

3. The product (3-in-1 barcode) tracing system established by the manufacturer is quite convenient for the tax audit. The circulation links are reduced, and the product directly reaches the consumer from the manufacturer, so as to greatly reduce the circulation cost.

VI. In Order to Maintain the Application of the 3-in-1 Barcode, it is Necessary to Establish a Computer Data Processing Center, a 3-in-1 Barcode Tracing System, and a 3-in-1 Barcode Query System.

The computer data processing center has the functions of encryption, decryption, encoding, decoding, network transmission, data query, data comparison, etc. An EAN-13 barcode database, the 3-in-1 barcode database, and the commercial cipher database are established, in which the commercial cipher database is used to manage the cipher key and the commercial cipher algorithm, so as to ensure the security thereof.

The data processing center collects EAN-13 code data and flow number code data of the commodities, and initializes the database. The data of the database is encrypted through the commercial cipher algorithm, so as to generate a verification code of 13-digit decimal number, and then store the verification code into the corresponding 3-in-1 barcode database. The above three groups of data are printed according to an order of lower, middle, and upper rows in the form of EAN-13 barcode, so as to obtain the “3-in-1 barcode”. Each commodity is authentified by one 3-in-1 barcode. The consumer reads the 3-in-1 barcode of a certain commodity by using a code-reading device, and transmits the 3-in-1 barcode to the data processing center over network. Then, the data processing center decodes the 3-in-1 barcode, converts the 3-in-1 barcode into three groups of 13-digit decimal numbers, and then decrypts the three groups of 13-digit decimal numbers through the commercial cipher algorithm, so as to perform the authentication on the validity of the 3-in-1 barcode. If it is valid, the EAN-13 barcode and the flow number code, i.e., the commodity authentification code, are generated, and then the EAN-13 barcode and the flow number code are compared with that in the initialized database, and the comparison result is provided to the user who makes the query; and if it is invalid, the commodity is a fake. When it is valid, the manufacturer gives a prompt about a certain state of the commodity at a certain time and a certain place, and accordingly, the consumer determines whether the 3-in-1 barcode is true or not according to the prompt, and if the 3-in-1 barcode is inconsistent with the prompt, the commodity is immediately called back, and the 3-in-1 barcode is abolished.

The 3-in-1 barcode tracing system: the manufacturer establishes a 3-in-1 barcode tracing system of each commodity from the production to reaching the consumers through circulation, so as to create the tracing file for each commodity.

The present invention is further illustrated below through the accompanying drawings and embodiments.

1. Applying for a Cipher Algorithm

The required commercial cipher algorithm, for example, the hash algorithm and the random number generation algorithm, is examined and approved according to Regulation on the Administration Commercial Cipher Codes.

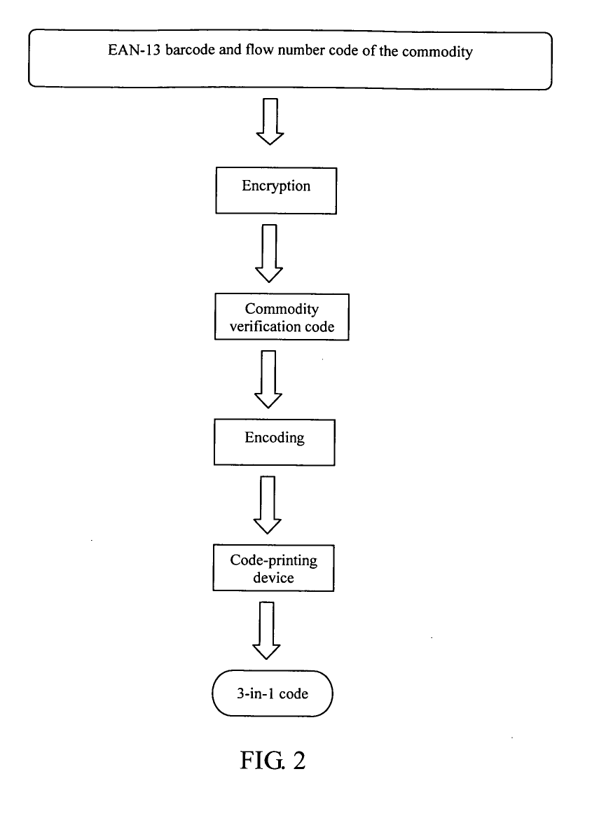

2. Generation of the 3-in-1 Barcode (See FIG. 2)

(1) Initialization: the data processing center collects the EAN-13 barcode and the flow number code of commodities, and initializes the database.

(2) Encryption: the data in the database is encrypted through the cipher algorithm, so as to generate a commodity verification code of 13-digit decimal number and store the commodity verification code into the corresponding cipher database.

(3) Encoding: the EAN-13 barcode, flow number code, and verification code of the commodity are divided into three groups of 13-digit decimal numbers and then stored into the 3-in-1 barcode database.

(4) Code printing: the obtained barcode is printed according to an order of lower, middle, and upper rows by taking the EAN-13 barcode as data carrier, such that the “3-in-1 barcode” is obtained.

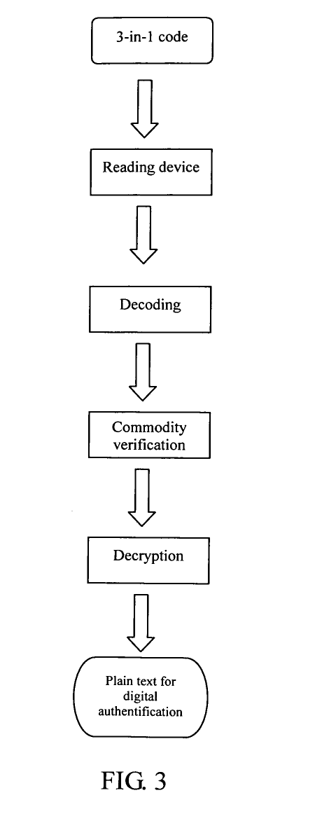

3. Identification of the 3-in-1 Barcode (See FIG. 3)

(1) Reading code: the consumer reads the 3-in-1 barcode through the code-reading device, and transmits the 3-in-1 barcode to the data processing center over network.

(2) Decoding: the data processing center decodes the 3-in-1 barcode, converts the 3-in-1 barcode into three groups of 13-digit decimal numbers, and stores the verification code into the cipher database.

(3) Decryption: the data processing center decrypts the verification code through the commercial cipher algorithm and generates two groups of 13-digit decimal numbers, i.e., authentification code.

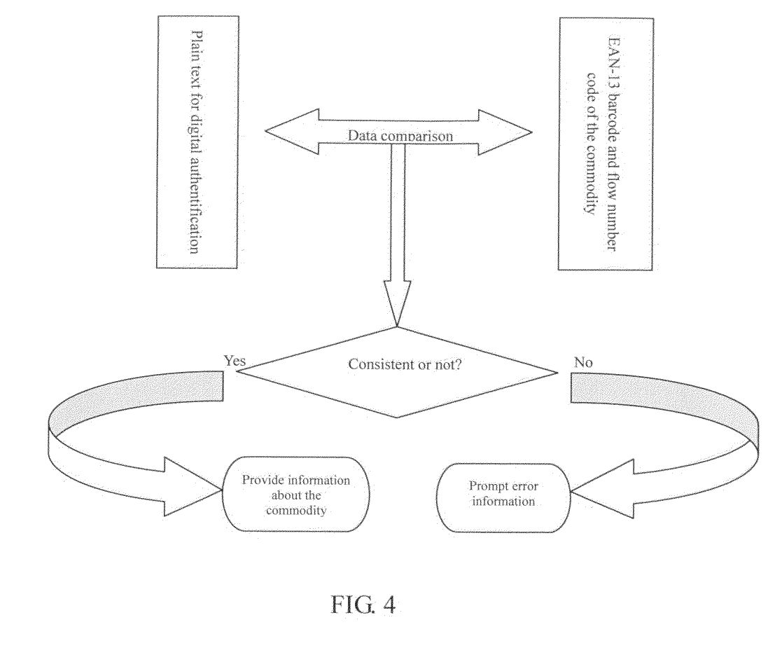

4. Comparison of the 3-in-1 Barcode (See FIG. 4):

(1) The data processing center compares the commodity authentification code with the EAN-13 barcode and the flow number of the commodity in the initialized database.

(2) The comparison result is fed back, if the commodity authentification code is consistent with the EAN-13 barcode and the flow number in the initialized database, a prompt about a certain state of the commodity at a certain time and certain place is generated; otherwise, a prompt that the commodity is fake or other error information is generated.

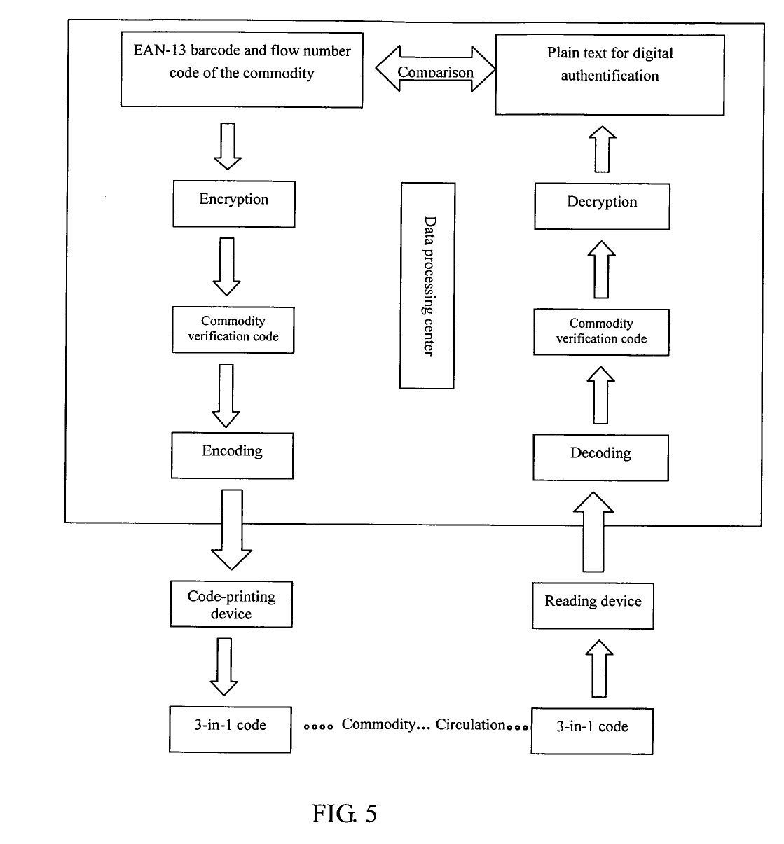

5. a Data Flow Chart of the 3-in-1 Barcode (See FIG. 5)

(1) The data processing center is established, which has functions of encryption, decryption, encoding, decoding, network transmission, data query, data comparison, etc.

(2) The data processing center collects the EAN-13 barcode data and the flow number code data of the commodities, which are two groups of 13-digit decimal numbers, and generates a group of 13-digit decimal number through encrypting the above two groups of 13-digit decimal numbers. The three groups of data are stored into the 3-in-1 barcode database. The computer prints the EAN-13 barcodes of the 3-in-1 barcode on the commodity. The 3-in-1 barcode is circulated along with the commodity. The user who makes a query reads the decimal data of the 3-in-1 barcode, or reads the EAN-13 barcode data of the 3-in-1 barcode, and then transmits the data to the data processing center. Then, the commodity verification code is decrypted to generate the EAN-13 barcode data and the flow number code of the commodity, which are two groups of decimal data, and to store them into the authentification code database. The authentification code database is compared with the initialized database, and the comparison result is fed back to the user.

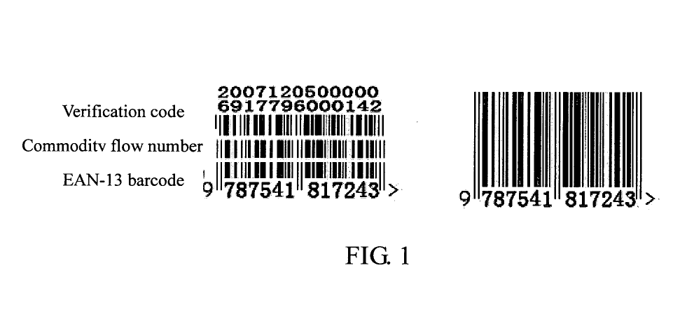

6. a Schematic View of the 3-in-1 Barcode and EAN-13 Barcode (See FIG. 1)

The 3-in-1 barcode is formed by the EAN-13 barcode, flow number code, and verification code of the commodities, which are respectively the upper, middle, and lower groups of barcodes.

What is claimed is:

1. A 3-in-1 barcode for identifying an commodity, comprising:
(1) acquiring a first and second group of data in the form of 13-digit decimal number that are input into a computer for being processed;
(2) determining whether the first group of data satisfies an global universal EAN-13 encoding principle or not, and whether the second group of data satisfies a commodity flow number encoding principle or not, and if yes, proceeding to the next step; otherwise, generating an error prompt;
(3) performing an encryption operation on the first group of data satisfying the EAN-13 encoding principle and the second group of data satisfying the commodity flow number encoding principle through a commercial cipher algorithm, and generating a 13-digit decimal verification code data, i.e., the third group of data;
(4) dividing the first group of data, the second group of data, and the third group of data into three rows by the computer, so as to obtain a 3-in-1 barcode;
(5) storing and printing the 3-in-1 barcode divided into three rows by the computer, for machine identification.

2. The 3-in-1 barcode for identifying an commodity according to claim 1, wherein an encoding principle for the second group of 13-digit decimal number, i.e., the commodity flow number encoding principle comprises: the 1^{st}-4^{th} digits indicate a 4-digit year code, the 5^{th}-6^{th} digits indicate a 2-digit month code, the 7^{th}-8^{th} digits indicate a 2-digit date code, and the 9^{th}-13^{th} digits indicate a 5-digit commodity flow number code.

3. The 3-in-1 barcode for identifying a commodity according to claim 1, wherein after the verification code is obtained, the verification code is decrypted through a commercial cipher algorithm to obtain the first and second group of data in the form of 13-digit decimal number.

4. The 3-in-1 barcode for identifying a commodity according to claim 1, wherein the first, second, and third groups of data are respectively printed in lower, middle, and upper rows by using EAN-13 barcodes.
